(19) United States
(12) Patent Application Publication
(10) Pub. No.: US 2018/0347620 A1
(43) Pub. Date: Dec. 6, 2018

(54) PUMP CRANKSHAFT

(71) Applicant: GARDNER DENVER PETROLEUM PUMPS LLC, Tulsa, OK (US)

(72) Inventor: James R. Yanus, Tulsa, OK (US)

(21) Appl. No.: 15/994,706

(22) Filed: May 31, 2018

Related U.S. Application Data
(60) Provisional application No. 62/513,590, filed on Jun. 1, 2017.

(51) Int. Cl. F16C 11/02; F16C 3/14

(52) U.S. Cl. CPC F16C 11/02; F04B 53/006; F16C 3/14

(57) ABSTRACT

A crankshaft assembly includes a crankshaft configured to be operatively coupled to prime mover and rotatable about a rotational axis. A crank pin is coupled to the crankshaft for rotation therewith about the rotational axis, the crank pin including an outer surface and a bore extending through the crank pin parallel to the rotational axis. The crank pin further includes a hole in fluid communication with the bore. The hole includes a first portion extending outward from the bore and a second portion coupled to and extending from the first portion and connected to the outer surface. The second portion is defined by a non-cylindrical shape in longitudinal cross-section. The hole further includes an inner fillet disposed at an interface between the first portion and the non-cylindrical portion, and an outer fillet disposed at an interface between the non-cylindrical portion and the outer surface.

### CROSS REFERENCE TO RELATED APPLICATIONS

This application claims priority to U.S. Provisional Patent Application No. 62/513,590 filed on Jun. 1, 2017, the entire contents of which are incorporated by reference herein.

### BACKGROUND

Well servicing pumps often include a plurality of reciprocating pistons or plungers that are driven by a drive end. The drive end includes a crankshaft that drives a plurality of connecting rods that in turn drive the plungers. The crankshaft includes a plurality of lube holes extending through the crankshaft for providing lubrication between the connecting rods and the crankshaft. This lubrication facilitates movement and reduces friction between the moving parts. Typical lube holes can compromise the structural integrity of the crank. A weakening of the crank around the mouth occurs during fabrication of the crank shaft. The weakened structure leads to cracking during operation around the mouth.

Also, existing servicing pumps have lube holes that may limit the fabrication of the crankshaft by inhibiting proper hardening of the areas surrounding the lube holes (e.g., due to overheating at the edges of the lube holes, which may cause theses edges to coarsen and become brittle). As such, the lube holes may weaken the structure of the crankshaft, and in particular at the edges of the lube holes. The weakened structure of the crankshaft may lead to hair cracks during operation and, after prolonged use, fatigue fractures, thereby decreasing the fatigue life of the crankshaft. In addition, the lube holes become a stress concentration during operation of the crankshaft, leading to propagation of cracking in the crankshaft, and a lower fatigue life.

Some existing technologies, for example crankshafts for internal combustion engines such as the one disclosed in U.S. Pat. No. 3,621,733, use slots extending from the radial periphery of the mouth of a lube hole or use a channel at the radial periphery to reduce cracking in connection with the lube hole. Alternatively, a bore may be provided proximate the lube hole such that the cracks propagate into the bore instead of the lube hole. However, these solutions do not eliminate the common wear problems of the crankshaft, and may only slightly increase fatigue life.

### SUMMARY OF THE INVENTION

The invention provides, in one aspect, a crankshaft assembly including a crankshaft that is configured to be operatively coupled to prime mover and rotatable about a rotational axis. A crank pin is coupled to the crankshaft for rotation therewith about the rotational axis, the crank pin including an outer surface and a bore extending through the crank pin parallel to the rotational axis. The crank pin further includes a hole in fluid communication with the bore. The hole includes a first portion extending outward from the bore and a second portion coupled to and extending from the first portion and connected to the outer surface. The second portion is defined by a non-cylindrical shape in longitudinal cross-section. The hole further includes an inner fillet disposed at an interface between the first portion and the non-cylindrical portion, and an outer fillet disposed at an interface between the non-cylindrical portion and the outer surface.

The invention provides, in another aspect, a crankshaft assembly including a crankshaft configured to be operatively coupled to prime mover and rotatable about a rotational axis. A crank pin is coupled to the crankshaft for rotation therewith about the rotational axis, the crank pin including an outer surface and a bore extending through the crank pin parallel to the rotational axis. The crank pin further includes a hole in fluid communication with the bore. The hole includes a first portion extending outward from the bore and a second portion coupled and extending from the first portion to the outer surface, the second portion defined by a frustoconical shape in longitudinal cross-section that tapers narrower from the outer surface inward toward the bore. The frustoconical shape of the second portion is configured to reduce stress in and around the hole adjacent the outer surface.

The invention provides, in another aspect, a crankshaft assembly including a crankshaft configured to be operatively coupled to prime mover and rotatable about a rotational axis. A crank pin coupled to the crankshaft for rotation therewith about the rotational axis, the crank pin including an outer surface and a bore extending through the crank pin parallel to the rotational axis. The crank pin further includes a hole in fluid communication with the bore. The hole includes a first portion extending outward from the bore and a second portion coupled to and extending from the first portion to the outer surface. The first portion has a cylindrical shape with a diameter, and the second portion is defined by a frustoconical shape in cross-section. The second portion expands from the inner diameter to an outer diameter that is larger than the inner diameter, and the second portion connects with the first portion at a depth of approximately 0.25 inches and approximately 1.50 inches from the outer surface.

Other features and aspects of the invention will become apparent by consideration of the following detailed description and accompanying drawings.

### BRIEF DESCRIPTION OF THE DRAWINGS

To easily identify the discussion of any particular element or act, the most significant digit or digits in a reference number refer to the figure number in which that element is first introduced.

FIG. 1 is a perspective view of a well servicing pump.

FIG. 2 is a section view of the well servicing pump of FIG. 1 taken along the reciprocating axis of one of the plungers.

FIG. 3 is a perspective view of a crankshaft for use in a well servicing pump.

FIG. 4 is another perspective view of the crankshaft of FIG. 3 with a section taken at one of the crank pins.

FIG. 5 is a section view of the crankshaft of FIG. 3 taken along the centerline of a lube hole normal to the rotational axis of the crankshaft.

FIG. 6 is an enlarged view of a portion of the lube hole of FIG. 5.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

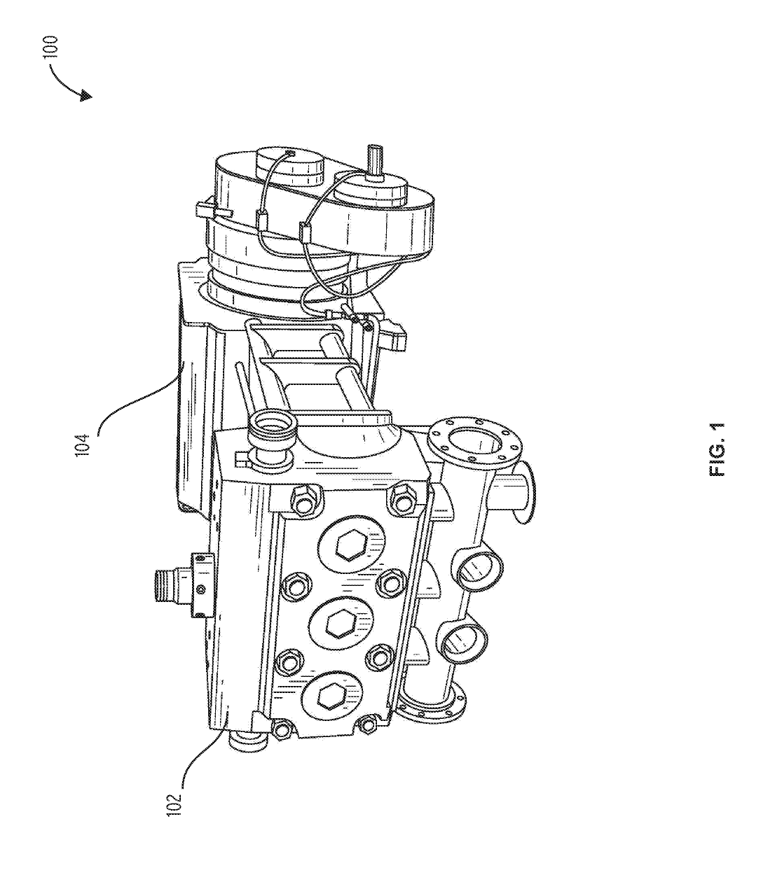

FIG. 1 illustrates a well servicing pump 100 that is commonly used in drilling operations such as oil drilling. The term “well servicing” is not intended to limit the functions performed by the pump and should not be read to limit the pump in any way.

Well servicing pumps 100 of this type often operate at pressures in excess of 15,000 psi and include a pump end 102 and a drive end 104 that operates to drive the pump end 102. The drive end 104 is connected to a prime mover such as an engine or motor that provides the necessary power to operate the pump end 102.

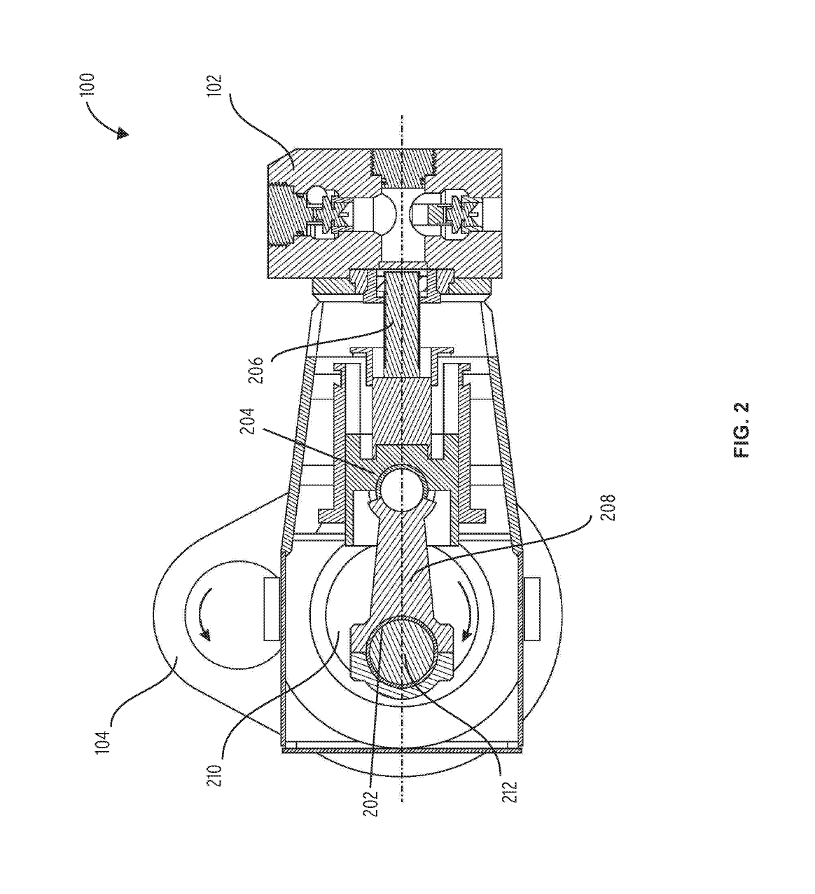

Turning to FIG. 2, a cross section of the well servicing pump 100 of FIG. 1 better illustrates the inner components. In FIG. 2 one of a plurality of plungers 206 is illustrated in an operating position. The plunger 206 is driven by the drive end 104 along a reciprocating path to alternatively draw liquid into the pump end 102 and discharge compressed fluid from the pump end 102. In preferred constructions, multiple plungers 206 are driven by the drive end 104 to produce the desired flow rate at the desired pressure.

The drive end 104 includes a connecting rod 208 and a crankshaft 210 that cooperate to drive the plunger 206. The crankshaft 210 is coupled to the prime mover to rotatably drive the crankshaft 210. In preferred constructions, a transmission is positioned between the prime mover and the crankshaft 210 to allow the rotational speed of the crankshaft 210 to be different than the rotational speed of the prime mover. Typically, the transmission provides a speed reduction of the crankshaft 210 when compared to the prime mover.

The connecting rod 208 includes a bore 202 that is sized to engage a crank pin 212 which is formed as part of the crankshaft 210. The connecting rod 208 also includes a drive portion 204 that either directly or indirectly drives the plunger 206 for reciprocation.

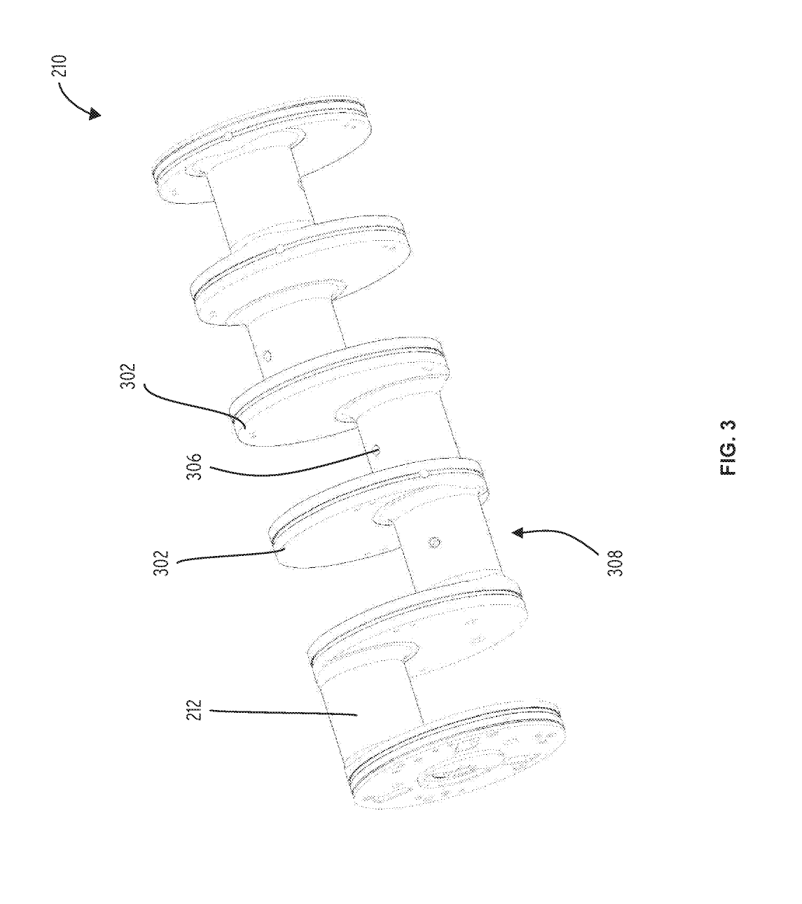

As illustrated in FIG. 3, the crankshaft 210 includes a plurality of webs 302 and a plurality of crank pins 212. Each crank pin 212 cooperates with two adjacent webs 302 to define a throw 308. Each throw 308 receives one of the connecting rods 208 to drive the connecting rod 208 as desired. Each of the webs 302 is arranged to fit within a bore and partially support the crankshaft 210 for rotation. In other constructions, a central shaft may extend from each end of the crankshaft 210 and include a journal surface for supporting the crankshaft 210 for rotation.

Each crank pin 212 includes a lube hole 306 that extends into the crank pin 212 and provides a portion of a lubrication flow path. In preferred constructions, the lube hole 306 is perpendicular to the central axis of the respective crank pin 212 and extends to the center of the crank pin 212.

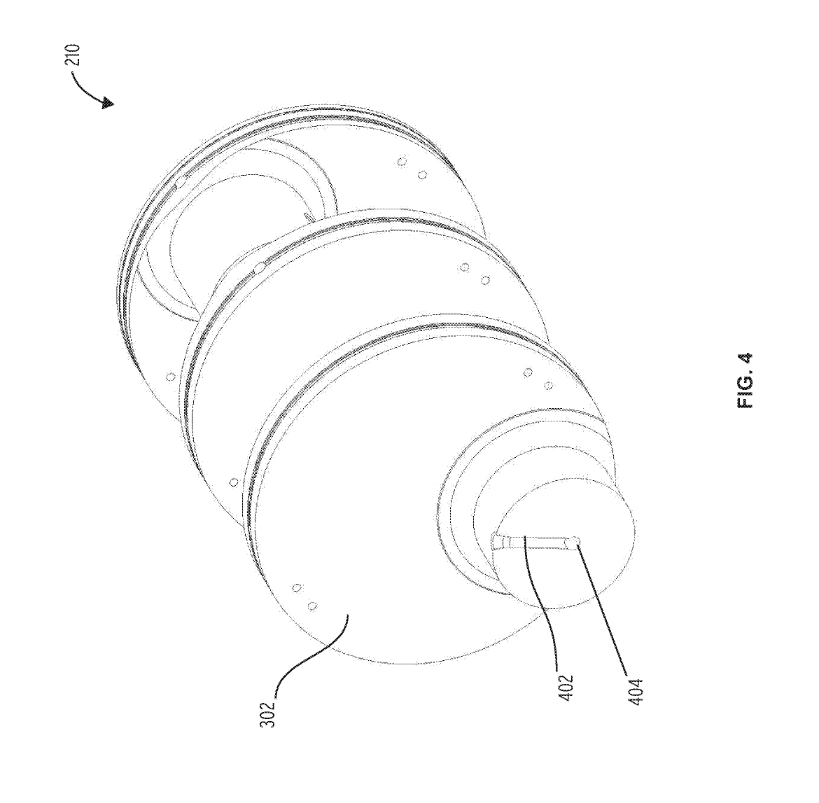

FIG. 4 illustrates a portion of the crankshaft 210 of FIG. 3 cut through the lube hole 306 of one of the crank pins 212. As can be seen, the lube hole 306 extends from the outer surface of the crank pin 212 to a central bore 404. Lubricant is pumped, under pressure, into the crankshaft 210 and along the central bore 404. The lubricant flows outward through the different lube holes 306 to provide fresh lubricant between the crank pin 212 and the bore 202 of the connecting rods 208.

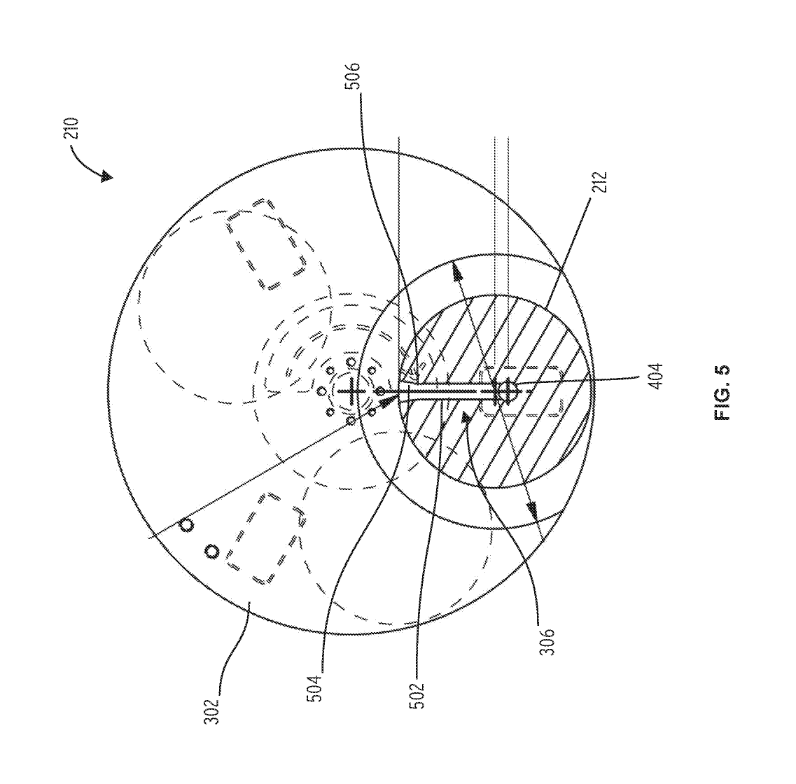

FIG. 5 is a section view taken through one of the lube holes 306 and normal to the axis of rotation of the crankshaft 210. The central bore 404 extends along the central axis of the crank pin 212 and interconnects the various lube holes 306 and the lubrication passages formed in the crankshaft 210.

The illustrated lube hole 306 includes a cylindrical portion 502 and a frustoconical or other non-cylindrical portion 504. The cylindrical portion 502 is about the same diameter as the central bore 404 and extends from the central bore 404 to an interface 506 with the frustoconical portion 504. In other constructions, the cylindrical portion 502 has a diameter that is different that the diameter of the central bore 404. The frustoconical portion 504 includes a small diameter portion that intersects with the cylindrical portion 502 at the interface 506. The frustoconical portion 504 expands to a larger diameter at the surface of the crank pin 212.

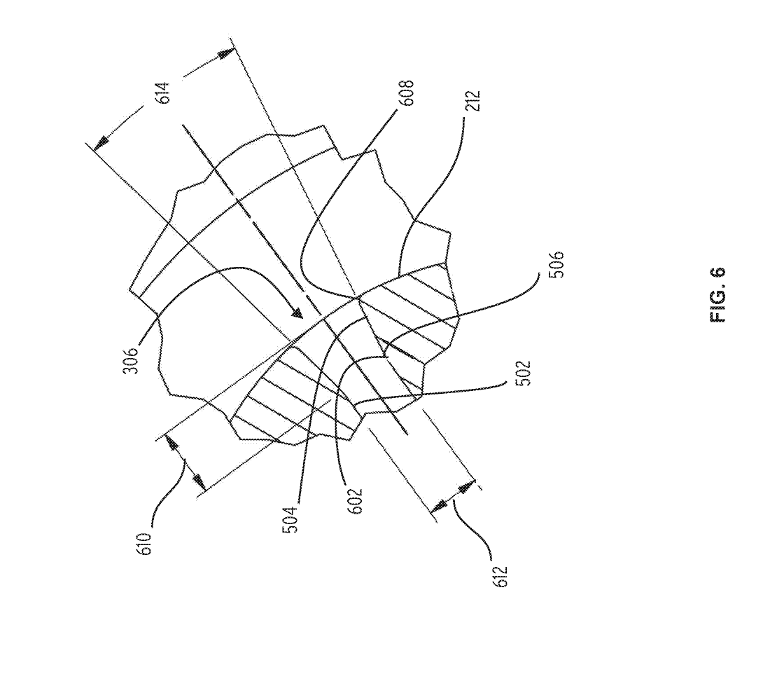

FIG. 6 better illustrates the outermost portion of the lube hole 306. The cylindrical portion 502 has a small diameter 612 that also defines the small diameter 612 of the frustoconical portion 504. The frustoconical portion 504 tapers from the small diameter 612 to a large diameter at a taper angle 614. The taper angle 614 and the small diameter 612 cooperate to define a depth 610 of the frustoconical portion 504. In preferred constructions, the taper angle 614 is about 25 degrees with angles between 10 degrees and 45 degrees being possible (this angle is double the half angle defined between the central axis of the hole and the wall defining the frustoconical portion). Preferably, the depth 610 of the frustoconical portion 504 is about 0.75 inches with other depths ranging from 0.25 inches to 1.50 inches. The term “about” as used herein is meant to encompass typical manufacturing tolerances for specific dimensions described.

In preferred constructions, a tapered or formed cutter is used to accurately form the frustoconical portion 504. In addition, an inner fillet 602 is formed at the interface 506 between the frustoconical portion 504 and the cylindrical portion 502. A second or outer fillet 608 is formed between the large diameter portion of the frustoconical portion 504 and the outer surface of the crank pin 212. The inner fillet 602 and the outer fillet 608 are sized and shaped and cooperate with the frustoconical portion 504 to reduce the stress in and around the lube hole 306 during operation of the crankshaft 210.

In operation, the crankshaft 210 is rotated under power provided by the prime mover. The connecting rod 208 connected to each throw 308, or the crank pin 212, moves in a circular path that produces the desired reciprocating motion of the drive portion 204 of the connecting rod 208 and in turn the plunger 206 or piston attached thereto. Lubricant, typically lubricating oil, is directed through the crankshaft and into the lube hole 306. The lubricant flows out of the lube hole 306 and lubricates the interface between the crank pin 212 and the connecting rod 208.

During a rotation, the surface of the crank pin 212 is subjected to a high compressive load as it pushes the connecting rod 208 and the plunger 206 to pressurize the fluid as well as a high torsional load as one crank pin 212 drives another sequential crank pin 212 toward the center of the crankshaft 210. During the intake portion of the stroke, the load on the crank pin 212 is greatly reduced. Thus, the surface of the crank pin 212 is exposed to a high cycle, high load change that can cause cracking or other fatigue damage. Unlike existing technologies, the shape of the upper portion of the lube hole 306 (i.e. the frustoconical portion 504 or other non-cylindrical wall, such as a hyperbolic or parabolic-shaped wall below the lube hole opening), as well as the inner fillet 602 and the outer fillet 608, expand the surface area of the lube hole 306. This is contrary to conventional and existing thinking that increasing the size of the lube hole, and especially the portion leading to the opening, was assumed to further weaken the crankshaft. After experimentation with frusto-conical, parabolic, hyperbolic, and other shaped-walls for the lube hole 306 near the opening, it was found that the load is distributed over the larger surface area such that the stress in and around the area of the lube hole 306 is reduced. This reduces the likelihood of damage during operation and extends the usable life of the crankshaft 210. As such, the crankshaft 210 including the lube hole 306 as described may be able to withstand a higher load and/or stress than crankshafts of the same size having conventional cylindrical lube holes. In addition, the shape of the lube hole 306 including the portion 504, the inner fillet 602, and the outer fillet 608 may all be machined in one step during cutting of the lube hole 306, which reduces the number of steps during fabrication of the crankshaft 210 in comparison to the crankshaft having a slot or bore as described in the prior art.

The embodiments discussed above provide a unique and novel solution to solving a common stress concentration by expanding the surface area of a lube hole just below the opening of the lube hole (e.g., via a conical frustum leading to the surface of the shaft as illustrated in the drawings, or via elliptical or otherwise non-circular shapes to the cutting path (shape opening), or changing the taper section by making it hyperbolic or parabolic in nature, or some series of compound radii. The ultimate effect of these exemplary lube holes is to make a high stress hole larger, which is contrary to what would be expected by one of ordinary skill in the art.

Some advantages of the embodiments described and illustrated herein include cost savings and weight for crankshafts by limiting the overall size of the envelope, which allows more load and operating stress in a smaller sized crankshaft. In addition, the foregoing embodiments effectively address a long-felt need in the industry by minimizing stress concentrations in a crankshaft while also effectively lubricating the crankshaft.

Although the invention has been described in detail with reference to certain preferred embodiments, variations and modifications exist within the scope and spirit of one or more independent aspects of the invention as described.

1. A crankshaft assembly comprising:
a crankshaft configured to be operatively coupled to a prime mover and rotatable about a rotational axis;
a crank pin coupled to the crankshaft for rotation therewith about the rotational axis, the crank pin including an outer surface and a bore extending through the crank pin parallel to the rotational axis, the crank pin further including a hole in fluid communication with the bore,
wherein the hole includes a first portion extending outward from the bore and a second portion coupled to and extending from the first portion and connected to the outer surface, the second portion defined by a non-cylindrical shape in longitudinal cross-section, and
wherein the hole further includes an inner fillet disposed at an interface between the first portion and the non-cylindrical portion, and an outer fillet disposed at an interface between the non-cylindrical portion and the outer surface.

2. The crankshaft assembly of claim 1, wherein the non-cylindrical portion tapers from the outer surface to the first portion to define a frustoconical shape in cross-section.

3. The crankshaft assembly of claim 1, wherein the non-cylindrical portion tapers at a taper angle between 10 degrees and 45 degrees.

4. The crankshaft assembly of claim 3, wherein the taper angle is 25 degrees.

5. The crankshaft assembly of claim 3, wherein the non-cylindrical portion tapers from the outer surface to a first diameter, wherein the first diameter and the taper angle cooperate to define a depth of the frustoconical portion, and wherein the depth between 0.25 inches and 1.5 inches.

6. The crankshaft assembly of claim 1, wherein the first portion has a cylindrical shape and includes a first diameter, and wherein the non-cylindrical portion connects to the cylindrical portion at an interface.

7. The crankshaft assembly of claim 1, wherein the non-cylindrical portion expands from a first diameter to a second diameter larger than the first diameter, wherein the first diameter is at the interface between the first portion and the non-cylindrical portion, and wherein the second diameter is at the interface between the non-cylindrical portion and the outer surface.

8. The crankshaft assembly of claim 7, wherein the first portion has a cylindrical shape, and wherein the first diameter defines a diameter of the cylindrical portion.

9. The crankshaft assembly of claim 1, wherein the first portion has a diameter, and wherein the diameter is the same as a diameter of the bore.

10. A crankshaft assembly comprising:
a crankshaft configured to be operatively coupled to a prime mover and rotatable about a rotational axis;
a crank pin coupled to the crankshaft for rotation therewith about the rotational axis, the crank pin including an outer surface and a bore extending through the crank pin parallel to the rotational axis, the crank pin further including a hole in fluid communication with the bore,
wherein the hole includes a first portion extending outward from the bore and a second portion coupled and extending from the first portion to the outer surface, the second portion defined by a frustoconical shape in longitudinal cross-section that tapers narrower from the outer surface inward toward the bore, the frustoconical shape of the second portion configured to reduce stress in and around the hole adjacent the outer surface.

11. The crankshaft assembly of claim 10, wherein the first portion is defined by a cylindrical shape in cross-section.

12. The crankshaft assembly of claim 11, wherein the second portion tapers at a taper angle between 10 degrees and 45 degrees.

13. The crankshaft assembly of claim 10, wherein the hole further has an outer fillet disposed at an interface between the second portion and the outer surface, and an inner fillet defined at the interface between the first portion and the second portion.

14. The crankshaft assembly of claim 10, wherein the crank pin is configured to be received within a bore of a connecting rod, wherein the hole defines a portion of a lubricant flow path, and wherein lubricant is configured to flow outward from the bore through the hole to provide lubricant between the crank pin and the bore of the connecting rod.

15. A crankshaft assembly comprising:
a crankshaft configured to be operatively coupled to prime mover and rotatable about a rotational axis;
a crank pin coupled to the crankshaft for rotation therewith about the rotational axis, the crank pin including an outer surface and a bore extending through the crank pin parallel to the rotational axis, the crank pin further including a hole in fluid communication with the bore,
wherein the hole includes a first portion extending outward from the bore and a second portion coupled to and extending from the first portion to the outer surface, the first portion having a cylindrical shape having a diameter, and the second portion defined by a frustoconical shape in cross-section,
wherein the second portion expands from the inner diameter to an outer diameter that is larger than the inner diameter, and
wherein the second portion connects with the first portion at a depth of approximately 0.25 inches and approximately 1.50 inches from the outer surface.

16. The crankshaft assembly of claim 15, wherein the second portion tapers at a taper angle between 10 degrees and 45 degrees.

17. The crankshaft assembly of claim 15, further comprising a fillet at the interface between the first portion and the second portion.

18. The crankshaft assembly of claim 15, further comprising a fillet at the interface between the second portion and the outer surface.

19. The crankshaft assembly of claim 15, further comprising a first fillet at the interface between the first portion and the second portion, and a second fillet at the interface between the second portion and the outer surface.

20. The crankshaft assembly of claim 15, wherein the diameter of the first portion is the same as a diameter of the bore.
